(19) United States
(12) Patent Application Publication
(10) Pub. No.: US 2026/0358061 A1
(43) Pub. Date: Nov. 12, 2026

(54) MODULAR RADIANT PANEL WITH HIGH HEAT EXCHANGE EFFICIENCY AND PRODUCTION METHOD THEREOF

(71) Applicant: Giacomini S.p.A., San Maurizio d'Opaglio (Novara), NO (IT)

(72) Inventors: Roberto Amato, San Maurizio d'Opaglio (IT); Paolo Arrus, San Maurizio d'Opaglio (IT); Alberto Franzi, San Maurizio d'Opaglio (IT); Marco Rosa Brusin, San Maurizio d'Opaglio (IT)

(73) Assignee: Giacomini S.p.A., San Maurizio d'Opaglio (Novara), NO (IT)

(21) Appl. No.: 19/135,120

(22) PCT Filed: Nov. 29, 2023
(86) PCT No.: PCT/IB2023/062021

§ 371 Date: Jun. 3, 2025

(30) Foreign Application Priority Data
Dec. 6, 2022 (IT) 102022000025116

(51) Int. Cl. F28D 1/047; B23P 15/26; F24F 5/00

(52) U.S. Cl. CPC F28D 1/0472; B23P 15/26; F24F 5/0089

(57) ABSTRACT

A radiant panel comprises a radiant plate and a coil comprising at least a pipe section suitable for the passage of a heat carrier fluid. The radiant plate and the coil are made of a metal material with high thermal conductivity. The radiant panel is made and assembled with at least one contiguous junction of the coil and the radiant plate obtained by electromagnetic forming (magnetoforming), electromagnetic presswork or electromagnetic pulse weld, by the contact surfaces of the coil and the radiant plate, using forces generated by an electromagnetic field. The invention also describes a production method of a radiant panel and a hydronic system made with said radiant panels obtained according to the method thereof.

### TECHNICAL FIELD

The present invention relates to a modular radiant panel with high heat transfer efficiency and a production method thereof.

More specifically, the present invention relates to a modular radiant panel with high heat transfer efficiency for hydronic heating and cooling systems for rooms and to a production method thereof or manufacturing process thereof.

### TECHNICAL BACKGROUND

The use of radiant panels suitable for forming heat transfer surfaces in rooms to be air-conditioned is well known and currently widely used in the field of thermal hydronic systems for heating and cooling rooms.

These radiant panels, which are typically modular, form a cladding and heat transfer surfaces that are generally fixed to the walls or ceilings of internal rooms to be air-conditioned, and comprising a radiant plate with a face or surface facing a room to be air-conditioned and the opposite surface facing the ceiling or the wall of the room. These panels are provided with a heating and cooling coil assembly in heat transfer contact with said radiant plate.

The radiant plate is typically made using a metal sheet that may also comprise a plurality of holes or openings, suitable for facilitating convective heat transfer or having a sound-absorbing function, arranged more or less uniformly over the surface of the plate so, as to cover it at least partially.

The coil assembly comprises a metal duct or pipe typically shaped as a coil and suitable for the passage of the heat carrier fluid and comprises a plurality of diffuser elements of cups interposed between at least a portion of the coil and the radiant plate. Said diffuser elements can be formed, for example, by an anodized aluminium sheet or a thermally conductive tile element.

The room air conditioning therefore occurs, for example in the case of heating, through conductive heat transfer from the heat carrier fluid to the coil and from the coil to the diffusers. The latter, being interposed between the coil and the radiant plate, operating as a thermal bridge by transferring the heat from the heat carrier to the radiant plate.

The heat transfer between the coil and the radiant plate therefore occurs indirectly, i.e., through the diffusers. In order to ensure this type of operation, the coil is fixed on the diffusers, by means of fixing elements such as clips, clamping, pressing, welding etc., while the diffusers are fixed and stabilized to the radiant plate by means of adhesive or bonding agent materials.

The conductive heat transfer between the coil and the radiant plate of a traditional radiant panel is thus essentially provided by the bridging portion of the contact surface defined by the diffusers or cups of the conductive adhesive or bonding agent material.

Traditional radiant panels may also have an insulating element designed to prevent beat loss through walls or ceilings.

A typical example of these well-known radiant panels is described in the Italian patent application No. 102017000110598 in the name of the Applicant of the present invention. Other examples of radiant panels according to prior art are described in GB 335 634 A and DE 20 2010 005787 U1.

These known radiant panels, however, have drawbacks and operating limitations.

A limitation of these radiant panels is the presence of the diffusers or cups and their means of attachment to the radiant plate and the coil, which, in addition to making the panel more complex and difficult to fabricate, generate thermal resistance both in the areas in contact with the fasteners and adhesive/bonding materials and in the areas that are simply in contact, a thermal resistance that decreases the efficiency of the exchange between the coil and the radiant plate.

Even in radiant panels where the coil is directly attached directly to the radiant plate by means of adhesive/bonding materials, without diffusers, the presence of the adhesive/bonding material, however, generates a thermal resistance at the junction portion of the coil with the radiant plate, such that it decreases the thermal exchange efficiency. The presence of the adhesive or bonding agent material, albeit of a thermally conductive type, interposed between the diffusers and the coil or between the coil and the radiant plate or between the diffusers and the radiant plate, results in a considerable decrease in heat transfer, compared to the thermal conductivity of the individual materials with which the radiant plate, diffusers and coil are made, generally in fact the thermal conductivity of the adhesive/adhesive materials is

### OBJECTS OF THE INVENTION

The object of the present invention is to overcome and obviate, at least in part, the above-mentioned drawbacks, and operational limitations of the prior art.

More specifically, an object of the present invention is to provide to the user a radiant panel and a related production method thereof, with a better general heat transfer efficiency.

A further object of the present invention is to provide a radiant panel and a production method thereof with a smaller number of elements, with reduced time of manufacturing and without the use of adhesive materials and bonding agents.

Not the least object of the present invention is to provide a radiant panel and a production method thereof that maintains the aesthetic characteristics of the finished radiant panel, without deformations and surface defects in painting and finishing, which can appear even after the activation/production step and commissioning of the system with radiant panels.

A further aim of the present invention is also to provide a radiant panel with a perforated radiant plate without diffusers which reducing the perforated or open area of the radiant plate, limiting its convective heat transfer.

A further purpose of the present invention is to make available a radiant panel and a related production method thereof, capable of guaranteeing a high level of resistance and reliability over time and which can also be easily and economically realizable.

These and other purposes are achieved by the modular radiant panel and the related production method thereof of the same object of the present invention in accordance with the independent claims.

The construction and functional characteristics of the modular radiant panel and of the production method thereof which is the object of the present invention can be better understood from the detailed description that follows, in which reference is made to the figures in the attached drawing tables which represent a preferred form of embodiment given to illustrative and non-limiting purposes.

### BRIEF DESCRIPTION OF THE FIGURES

FIG. 1a is a schematic axonometric and exploded representation of a radiant panel which is the subject of the present invention, with the coil separated from the radiant plate;

FIG. 2 is a schematic axonometric and exploded representation of a radiant panel according to the known art with the coil fixed to the radiant plate by means of diffusers;

FIG. 3 is a schematic axonometric representation of a radiant panel which is the subject of the present invention, provided with diffusers between the coil and the radiant plate;

FIGS. 4, 5 and 6 are schematic perspective cross-section representations of the succession of steps of the junction process through electromagnetic forming of the coil tube with the radiant panel to obtain an embodiment of the finished thermoformed radiant panel.

FIGS. 7, 8 and 9 are schematic perspective cross-section representations of the succession of steps of the junction process via electromagnetic forming of the coil tube and the radiant plate with a diffuser element to obtain a further embodiment of the finished thermoformed radiant panel.

### DETAILED DESCRIPTION OF THE INVENTION

With reference to the figures, is shown with the reference number 10 a modular radiant panel subject of the present invention.

The radiant panel 10 comprises a panel or radiant plate 12 and a coil 14 comprising a pipe section 14′ suitable for the passage of a heat carrier fluid.

Said radiant plate 12 is preferably made of metallic material with high thermal conductivity such as steel, aluminium and its alloys and can comprise a plurality of through holes or openings (not shown) obtained on its heat transfer surface.

The coil 14 generally comprises at least a section of metal tube 14′ with high thermal conductivity, generally made of steel, copper, aluminium and their alloys, said coil 14 being suitable for the passage of a heat carrier fluid and configured to be able to be placed in connection with fluid with a collector or with metal tubes of coils of adjacent radiant panels.

Said radiant panel 10 is made and assembled with an innovative process or method of contiguous junction of the coil 14 and the radiant plate 12 obtained by means of processes called electromagnetic forming (magnetoforming), electromagnetic presswork or electromagnetic pulse weld, in correspondence with the contact surfaces between said coil 14 and said radiant plate 12, with the use of forces generated by an electromagnetic field without traditional means of fixing adhesive and bonding agent materials, plastic deformations, staples or clips etc.

In this description, the term contiguous junction refers to a stable junction which involves the intimate union of the crystalline structures and the localized interpenetration of the metallic materials in contact, even those different from each other, without the addition of junction elements and filler material.

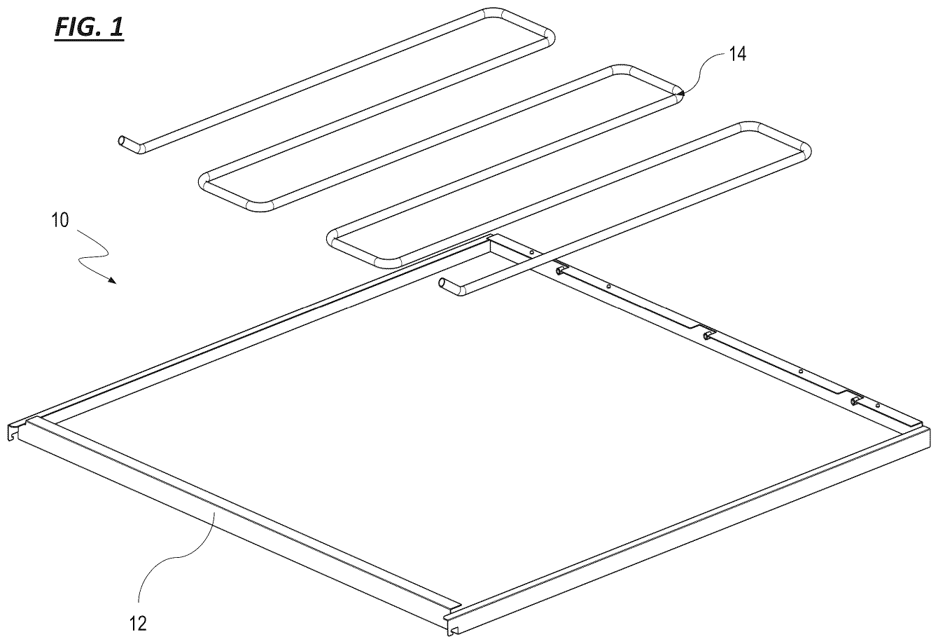

With reference to FIG. 1, in a general embodiment, said coil 14 is joined to the radiant plate 12 by means of a contiguous junction obtained by means of processes called electromagnetic forming, electromagnetic presswork or electromagnetic pulse weld, between said coil 14 directly on said radiant plate 12 without any diffuser and without traditional means of fixing adhesive and bonding agent materials, plastic deformations, staples or clips etc.

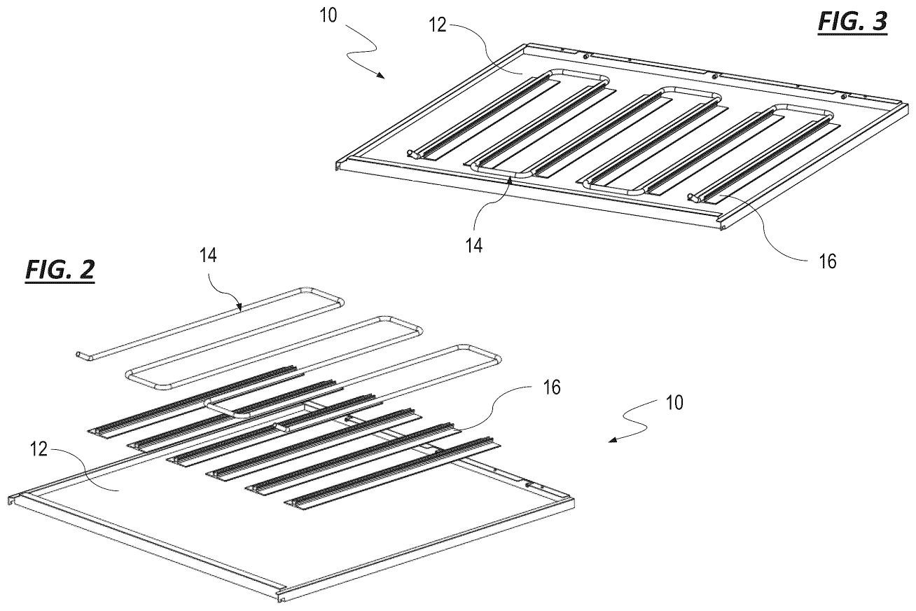

With reference to FIGS. 2 and 3, in some alternative embodiments, said radiant panel 10 can also comprise at least one diffuser 16 capable of being fixed at its contact surfaces to the other elements of the radiant panel 10 with a contiguous junction obtained with a process of electromagnetic forming, electromagnetic presswork or electromagnetic pulse weld.

With reference again to FIGS. 2 and 3, in an alternative embodiment said diffuser 16 made of metallic material is fixed to said radiant plate 12 with a contiguous junction obtained with an electromagnetic forming, electromagnetic presswork or electromagnetic pulse weld process on the contact surface between said diffuser 16 and said radiant plate 12.

With reference to all of the figures, in an alternative embodiment form of said radiant panel 10, said at least one diffuser 16 can be fixed to said coil 14 with a contiguous junction obtained with an electromagnetic forming, electromagnetic presswork or electromagnetic pulse weld process while it is fixed to said radiant plate 12 with traditional fixing means such as adhesive materials or bonding agents.

With reference again to FIGS. 2 and 3, in a further embodiment of said radiant panel 10, said at least one diffuser 16 can be fixed to said radiant plate 12 and to said coil 14 with a contiguous junction obtained with a process of electromagnetic forming, electromagnetic presswork or electromagnetic pulse weld without fixing means such as adhesive and bonding agent materials, plastic deformations, staples or clips etc.

Further alternative variant embodiments, not shown, fall within the scope of protection of this description wherein only said coil 14 or only said radiant plate 12 are fixed with said diffuser 16 with a contiguous junction obtained with a electromagnetic forming, electromagnetic presswork or electromagnetic pulse weld process, while the other fixing with said diffuser 16 is obtained with traditional fixing means such as adhesive and bonding agent materials, plastic deformations, staples or clips etc.

The object of the present invention is also a method or a process for the production of a modular radiant panel (10), as described above, obtained with the fixing of its parts by means of one or more electromagnetic forming, electromagnetic presswork, or electromagnetic pulse weld processes between contact surfaces of the parties.

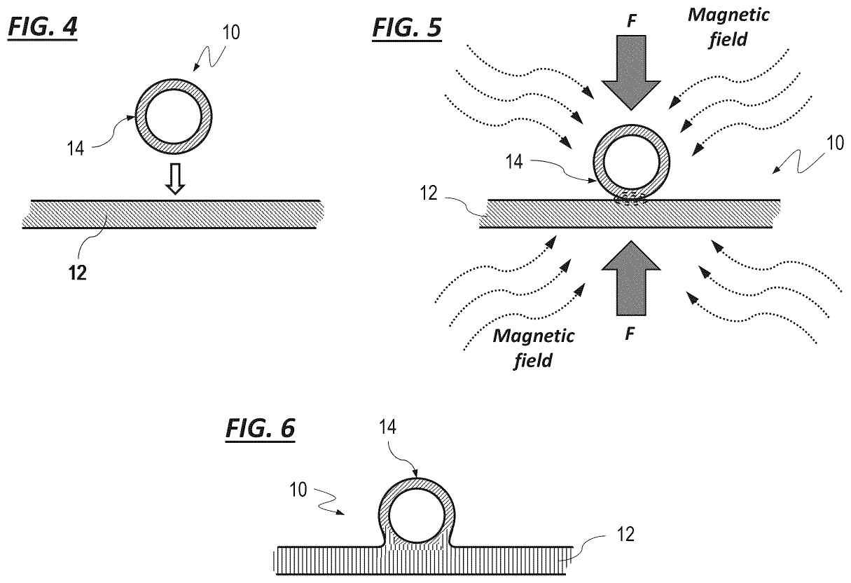

With reference to FIGS. 4 to 6, the invention therefore also refers to a production method of a radiant panel 10 which comprises the steps of:
providing a radiant plate 12 made of metallic material;
providing a coil 14 comprising at least a pipe section 14′ made of metallic material;
arranging said coil 14 on said radiant plate 12;
applying a localized magnetic field on the contact surfaces of said coil 14 and said radiant plate 12;
obtaining, as a consequence of the application of said magnetic field, a contiguous and stable junction with union of the crystalline structures and localized interpenetration of the contact surfaces of the materials of the parts that make up said radiant panel 10.

In a general embodiment of the production method subject of the present invention, the step of obtaining, as a consequence of the application of said magnetic field, a contiguous and stable junction with union of the crystalline structures and localized interpenetration of the contact surfaces of the materials, comprises the step of the obtaining of a contiguous junction made between said coil 14 directly on said radiant plate 12, without diffusers, fixing means or adhesive and bonding agent materials.

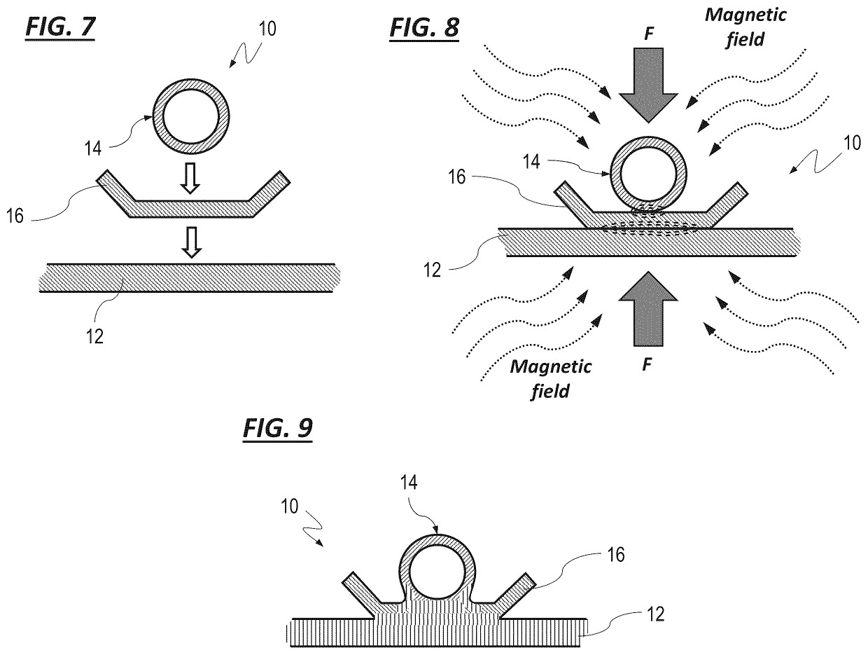

In further possible alternative embodiments, also with reference to FIGS. 7 to 9, the production method can comprise, before the step of applying a magnetic field, also the steps of:
providing a diffuser 16;
arranging said diffuser 16 with said coil 14 on said radiant plate 12.

With reference again to FIGS. 7 to 9, in a possible alternative variant of the method object of the present invention, the step of obtaining, as a consequence of the application of said magnetic field, a contiguous and stable junction with union of the crystalline structures and localized interpenetration of the contact surfaces of the materials, can comprise the step of obtaining several contiguous junctions made between said coil 14 and said radiant plate 12 with said diffuser 16.

In a further variant embodiments of the method subject of the present invention, the step of obtaining, as a consequence of the application of said magnetic field, a contiguous and stable junction with union of the crystalline structures and localized interpenetration of the contact surfaces of the materials, comprises the step of obtaining of a contiguous junction made only between said diffuser 16 and said radiant plate 12, while generally the coil 14 can be fixed to the same diffuser 16 with traditional fixing means such as for example adhesive and bonding agent materials, plastic deformations, staple clips, etc.

In a further alternative variant form of the method object of the present invention, the step of obtaining, as a consequence of the application of said magnetic field, a contiguous and stable junction with union of the crystalline structures and localized interpenetration of the contact surfaces of the materials, comprises the step of obtaining a contiguous junction made between said diffuser 16 and said coil 14 and comprises a further step of
fix said diffuser 16 to said radiant plate 12 with traditional fixing means such as adhesive or bonding agent materials, plastic deformations, staples, or clips etc.

In a further alternative variant embodiment of the method subject of the present invention, the step of obtaining, as a consequence of the application of said magnetic field, a contiguous and stable junction with union of the crystalline structures and localized interpenetration of the contact surfaces of the materials, comprises the step of obtaining a contiguous junction made between said diffuser 16 both with said radiant plate 12 and with said coil 14.

In the steps of arranging the coil 14 on the radiant plate 12 or of arranging the diffuser 16 between the radiant plate 12 and the coil 14, said elements to be joined by means of electromagnetic forming are freely arranged in surface contact with each other before the application step of the magnetic field, without any definitive fixing and advantageously even with the external surfaces already finished or painted. It is understood, however, that it will be clear to a person skilled in the field the possibility of using brackets, squares, centering pins, positioning templates, or masks or other means for the precise arrangement of the elements constituting the radiant panel 10 in order to guarantee the measurements and dimensional homogeneity in the industrial production of single radiant panels 10.

Finally, the invention also relates to a hydronic system for thermal heating and cooling of rooms comprising one or more radiant panels 10 as previously described.

From the description of the radiant panel 10 and the related production method thereof which is the subject of the present invention, the operation described below are clear.

With reference to the various figures, the present invention allows the innovative manufacturing of a radiant panel with the union of the metallic elements that form it, even of different metals, through the application of a magnetic field that generates high forces and impulsive pressures in a very limited time interval such as to lead to a process called electromagnetic forming, electromagnetic presswork or electromagnetic pulse weld with an interpenetration and an intimate union of the metal surfaces due to the collapse of the atoms of the metallic crystalline structures of the elements of the radiant panel 10 and a consequent permanent junction with a limited generation of heat, compared to a traditional welding process, on the entire contact surface or only on a part with a mechanically stable junction with a thermal conductivity close to that of the materials of the individual elements of the radiant panel 10. The limited generation of heat in the electromagnetic forming process prevents the formation of thermally distorted and deformed areas on elements and guarantees very low elastic returns as well as making the process more energetically advantageous and economical compared to traditional welding.

As can be seen from the foregoing, the advantages that the modular radiant panel and the related production method thereof subject of the present invention achieve are evident.

The radiant panel 10 and the related production method thereof subject of the present invention are particularly advantageous because they provide to the user a radiant panel with improved general thermal efficiency thanks to a greater thermal conductivity between the various parts joined directly together by electromagnetic forming, electromagnetic presswork or electromagnetic pulse weld without the need for diffuser elements and without the use of fixing means and adhesive and bonding agent materials that represent a resistance to thermal transmission.

A further advantage of the radiant panel 10 and the related production method thereof which is the object of the present invention is due to the fact that the junction obtained by electromagnetic forming, electromagnetic presswork or electromagnetic pulse weld is more homogeneous and continuous over the entire contact surface between the various elements and such as to avoid shrinkage or deformations that can cause detachments between the parts, superficial aesthetic defects.

A further advantage of the radiant panel 10 and the related production method thereof which is the object of the present invention is due to the fact that the junction obtained by electromagnetic forming, electromagnetic presswork or electromagnetic pulse weld defines a localized junction which does not cover any holes or through openings made on the heat transfer surface of the radiant plate 12 increasing the convective heat transfer efficiency of the panel and its aesthetic pleasure.

A further advantage of the radiant panel 10 and related production method thereof which is the object of the present invention is due to the fact that the junction obtained by electromagnetic forming, electromagnetic presswork advantageously allows the union of parts, radiant plate 12, coil 14 or diffusers 16, already superficially finished or painted, therefore with savings in production times and costs.

Although the invention has been described above with particular reference to some preferred embodiments, given for illustrative and non-limiting purposes, numerous modifications and variations will appear evident to a person skilled in the art in light of the above description. The present invention, therefore, intends to embrace all the modifications and variations that fall within the scope of protection of the following claims.

1. A radiant panel comprising
a radiant plate; and
a coil;
wherein the coil comprises at least one pipe section suitable for the passage of a heat carrier fluid;
wherein the radiant plate and the coil are made of a metal material with high thermal conductivity;
wherein the radiant panel is made and assembled with at least one contiguous junction of the coil and the radiant plate obtained by at least one of electromagnetic forming (magnetoforming), electromagnetic presswork and electromagnetic pulse weld, by contact surfaces of the coil and the radiant plate using forces generated by an electromagnetic field.

2. The radiant panel according to claim 1, wherein the at least one contiguous junction is made between the coil directly on the radiant plate.

3. The radiant panel according to claim 1, further comprising at least one diffuser suitable for being fixed in correspondence with the contact surfaces of the radiant plate and the coil and with the at least one contiguous junction.

4. The radiant panel according to claim 3, wherein the at least one diffuser is fixed to the coil using the at least one contiguous junction; and wherein the diffuser is fixed to the radiant plate using at least one of adhesive material and bonding agent material.

5. The radiating panel according to claim 3, wherein the at least one diffuser is attached to both the radiant plate and the coil using the at least one contiguous junction.

6. The radiant panel according to claim 1, wherein the radiant plate comprises one or more through holes or ports on its heat transfer surface.

7. The radiant panel according to claim 1, wherein the radiant plate is made of at least one of steel, aluminum, and alloys thereof.

8. The radiant panel according to claim 1, wherein the at least one pipe section of the coil is made of at least one of steel, copper, aluminum, and alloys thereof.

9. A production method of a radiant panel comprising the steps of:
providing a radiant plate made of a metallic material;
providing a coil comprising at least one pipe section made of a metallic material;
placing the coil on the radiant plate;
applying a localized magnetic field to contact surfaces of materials to be joined;
wherein applying the magnetic field results in a contiguous junction with union of crystalline structures and localized interpenetration of the contact surfaces of the materials to be joined.

10. The method according to claim 9, wherein the contact surfaces of the materials to be joined comprises the contact surfaces of the coil and the radiant plate so that the contiguous junction is made between the coil and the radiant plate.

11. The method according to claim 9, wherein prior to the step of applying the magnetic field, the method further comprises the steps of:
providing a diffuser; and
creating the contiguous junction between the diffuser and the coil (14) on the radiant plate (12).

12. The method according to claim 11, wherein the contiguous junction is made between the diffuser and the radiant plate.

13. The method according to claim 11, wherein the step of creating the contiguous junction between the diffuser and the coil further comprises the step of:
attaching the diffuser to the radiant plate using at least one of an adhesive and bonding agent materials.

14. The method according to claim 11, wherein the contiguous junction is made between the diffuser and both the radiant plate and the coil.

15. A hydronic heating and cooling system comprising at least one radiant panel, wherein the at least one radiant plate panel comprises:
a radiant plate; and
a coil;
wherein the coil comprises at least one pipe section suitable for the passage of a heat carrier fluid;
wherein the radiant plate and the coil are made of a metal material with high thermal conductivity;
wherein the radiant panel is made and assembled with at least one contiguous junction of the coil and the radiant plate obtained by at least one of electromagnetic forming (magnetoforming), electromagnetic presswork and electromagnetic pulse weld, by contact surfaces of the coil and the radiant plate using forces generated by an electromagnetic field.
